(19) United States
(12) Patent Application Publication
(10) Pub. No.: US 2003/0220788 A1
(43) Pub. Date: Nov. 27, 2003

(54) System and method for speech recognition and transcription

(75) Inventor: Joshua D. Ky, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: XL8 Systems, Inc., Dallas, TX (US)

(21) Appl. No.: 10/458,748

(22) Filed: Jun. 10, 2003

Related U.S. Application Data
(63) Continuation-in-part of application No. 10/022,947, filed on Dec. 17, 2001.

(51) Int. Cl. G10L 15/26

(52) U.S. Cl. 704/235

(57) ABSTRACT

The present invention comprises a method for speech recognition comprises receiving a digital representation of speech, grouping the digital representation of speech into subsets, mapping each subset of the digital representation of speech into a character representation of speech, grouping the character representations of speech into words, determining the number of syllables in the digital representation of each word, and searching a library containing words arranged according to the number of syllables and finding at least one closest match to each word.

### RELATED APPLICATIONS

The present patent application is a continuation-in-part of U.S. patent application Ser. No. 10/022,947 (Attorney Docket No. 5953.2-1), filed on Dec. 17, 2001, entitled “SYSTEM AND METHOD FOR SPEECH RECOGNITION AND TRANSCRIPTION,” and also related to co-pending U.S. patent application Ser. No. 10/024,169 (Attorney Docket No. 5953.3-1), filed on Dec. 17, 2001, entitled “SYSTEM AND METHOD FOR MANAGEMENT OF TRANSCRIBED DOCUMENTS.”

### TECHNICAL FIELD OF THE INVENTION

The present invention relates to the field of speech recognition and transcription.

### BACKGROUND OF THE INVENTION

Speech recognition is a powerful tool for users to provide input to and interface with a computer. Because speech does not require the operation of cumbersome input tools such as a keyboard and pointing devices, it is the most convenient manner for issuing commands and instructions, as well as transforming fleeting thoughts and concepts into concrete expressions or words. This is an especially important input mechanism if the user is incapable of operating typical input tools because of impairment or inconvenience. In particular, users who are operating a moving vehicle can more safely use speech recognition to dial calls, check email messages, look up addresses and routes, dictate messages, etc.

Some elementary speech recognition systems are capable of recognizing only a predetermined set of discrete words spoken in isolation, such as a set of commands or instructions used to operate a machine. Other speech recognition systems are able to identify and recognize particular words uttered in a continuous stream of words. Another class of speech recognition systems is capable of recognizing continuous speech that follows predetermined grammatical constraints. The most complex application of speech recognition is the recognition of all the words in continuous and spontaneous speech useful for transcribing dictation applications such as for dictating medical reports or legal documents. Such systems have a very large vocabulary and can be speaker-independent so that mandatory speaker training and enrollment is not necessary.

Conventional speech recognition systems operate on recognizing phonemes, the smallest basic sound units that words are composed of, rather than words. The phonemes are then linked together to form words. The phoneme-based speech recognition is preferred in the prior art, however because very large amounts of random access memory is required to match words to sample words in the library, it is impracticable and slow.

### SUMMARY THE INVENTION

In one aspect of the invention, a method for speech recognition comprises receiving a digital representation of speech, grouping the digital representation of speech into subsets, mapping each subset of the digital representation of speech into a character representation of speech, grouping the character representations of speech into works, determining the number of syllables in the digital representation of each word, and searching a library containing words arranged according to the number of syllables and finding at least one closest match to each word.

In another aspect of the invention, a speech recognition and transcription method comprises receiving a user identity, providing a script of known text to a user, receiving a digital representation of speech of the script spoken by the user, grouping the digital representation of speech into subsets, comparing the subsets to predetermined thresholds and assigning the user to a speech zone in response to the comparisons, and storing the user identity and the speech zone assignment associated therewith.

In yet another aspect of the invention, a speech recognition and transcription method comprises receiving and storing a user identity from a user, displaying a script of known text, receiving a binary bit stream representation of the script spoken by the user, grouping the binary bit stream into N binary bit groups, comparing the N binary bit groups to predetermined thresholds and assigning the user to one of a plurality of speech zones in response to the comparisons, and storing the speech zone assignment associated with the stored user identity.

### BRIEF DESCRIPTION OF THE DRAWINGS

For a more complete understanding of the present invention, the objects and advantages thereof, reference is now made to the following descriptions taken in connection with the accompanying drawings in which:

FIGS. 1A to 1C are a top-level block diagrams of embodiments of a speech recognition system;

FIG. 2 is a functional block diagram of an embodiment of the speech recognition system according to the teachings of the present invention;

FIG. 3 is a flowchart of an embodiment of the speech recognition training process according to the teachings of the present invention;

FIG. 4 is an exemplary plot of the four speech zones according to the teachings of the present invention;

FIG. 5 is a flowchart of an embodiment of the speech recognition process according to the teachings of the present invention;

FIG. 6 is a flowchart of an embodiment of the correction process according to the teachings of the present invention; and

FIGS. 7A to 7C are time varying waveforms of the words “Hello Joshua” uttered by three different individuals of both sexes.

### DETAILED DESCRIPTION OF THE DRAWINGS

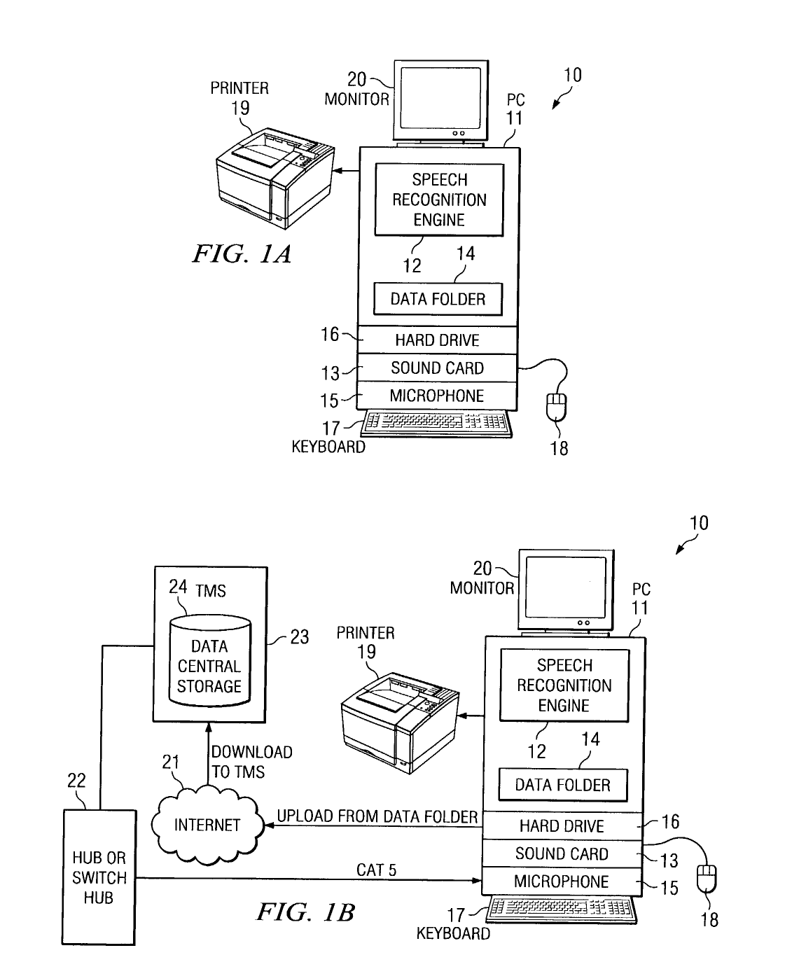

The preferred embodiment of the present invention and its advantages are best understood by referring to FIGS. 1 through 7 of the drawings, like numerals being used for like and corresponding parts of the various drawings.

FIG. 1A is a top-level block diagram of one embodiment of a speech recognition system 10. As shown in FIG. 1A is a stand-alone speech recognition system 10, which includes a computer 11, such as a personal computer, workstation, laptop, notebook computer and the like. Suitable operating systems running on computer 11 may include WINDOWS, LINUX, NOVELL, UNIX, etc. Other microprocessor-based devices, if equipped with sufficient computing power and speed, such as personal digital assistants, mobile phones, and other mobile or portable devices may also be considered as possible platforms for speech recognition system 10. Computer 11 executes a speech recognition engine application 12 that performs the speech utterance-to-text transformation according to the teachings of the present invention. Computer 11 is further equipped with a sound card 13, which is an expansion circuit board that enables a computer to receive, manipulate and output sounds. Speech and text data are stored in data structures such as data folders 14 in memory or data storage devices, such as a hard drive 16. Transcribed reports and other data related to system 10 may also be stored in local hard drive 16. Computer 11 is also equipped with a microphone 15 that is capable of receiving sound or spoken word input that is then provided to sound card 13 for processing. User input devices of computer 11 may include a keyboard 17 and a pointing devices such as a mouse 18. Hardcopy output devices coupled to or associated with computer 11 may include a printer 19, facsimile machine, digital sender and other suitable devices. Not explicitly shown are speakers coupled to computer 11 for providing audio output from system 10. Sound card 13 enables computer 11 to output sound through the speakers connected to sound card 13, to record sound input from microphone 15 connected to the computer, and to manipulate the data stored in the data files and folders. Speech recognition system 10 is operable to recognize spoken words either received live from microphone 15 via sound card 13 or from voice files stored in data folders 14 in local or network storage.

As an example, a family of sound cards from CREATIVE LABS, such as the SOUND BLASTER LIVE! CT4830 and CT4810 are 16-bit sound cards that may be incorporated in speech recognition system 10. System 10 can also take advantage of future technology that may yield 16+ bit sound cards that will provide even better quality sound processing capabilities. Sound card 13 includes an analog-to-digital converter (ADC) circuit or chip (not explicitly shown) that is operable to convert the analog signal of sound waves received by microphone 15 into digital representation thereof. The analog-to-digital converter accomplishes this by sampling the analog signal and converting the spoken sound to waveform parameters such as pitch, volume, frequency, periods of silence, etc. Sound card 13 may also include sound conditioning circuits or devices that reduce or eliminate spurious and undesirable components from the signal. The digital speech data is then sent to a digital signal processor (DSP) (not explicitly shown) that processes the binary data according to a set of instructions stored on the sound card. The processed digital sound data is then stored to a memory or storage device, such as memory, a hard disk, a CD ROM, etc. In the present invention, speech recognition system 10 includes software code that receives the processed digital binary data from the sound card or from the storage device to perform the speech recognition function.

Referring to FIG. 1B, speech recognition system 10 may be in communication, via a computer network 21 and an interface such as a hub or switch hub 22, with a transcription management system (TMS) 23 operable to manage the distribution and dissemination of the transcribed speech reports. Computer network 21 may be a global computer network such as the Internet, intranet or extranet, and is used to transfer and receive data, commands and other information between speech recognition system 10 and transcription management system 23. Suitable communication protocols such as the File Transfer Protocol (FTP) may be used to transfer data between the two systems. Computer 11 may upload data to system 23 using a dial-up modem, a cable modem, a DSL modem, an ISDN converter, or like devices (not explicitly shown). The file transfer between systems 10 and 23 may initiated by either system to upload or download the data. Transcription management system 23 includes a computer and suitable peripherals such as a central data storage 24 which houses data related to various transcription report recipients, the manner in which the transcription reports should be sent, and the transcription reports themselves. Transcription management system is capable of transmitting the transcription reports to the intended recipients via various predetermined modes, such as electronic mail, facsimile, or via a secured web site, and is further capable of sending notifications via pager, email, facsimile, and other suitable manners. Transcription management system 23 is typically in communication with multiple speech recognition systems 10 that perform the speech-to-text function. Details of the transcription management system is provided in co-pending U.S. patent application Ser. No. 10/024,169 (Attorney Docket No. 5953.3-1), filed on Dec. 17, 2001, entitled “SYSTEM AND METHOD FOR MANAGEMENT OF TRANSCRIBED DOCUMENTS.”

FIG. 1C is a simplified block diagram of a yet another embodiment of the speech recognition system. A network such as a local area network (LAN), wide area network (WAN) using a connection such as Category 5 cable, T1, ISDN, dial-up connection, virtual private network (VPN), with a hub or switch hub 26 may be used to interconnect multiple speech recognition systems 10, 10″, 10′″ to facilitate file and data sharing. Any one or more of systems 10, 10″, 10′″ may be similarly configured to communicate with a transcription management system such as shown in FIG. 1B.

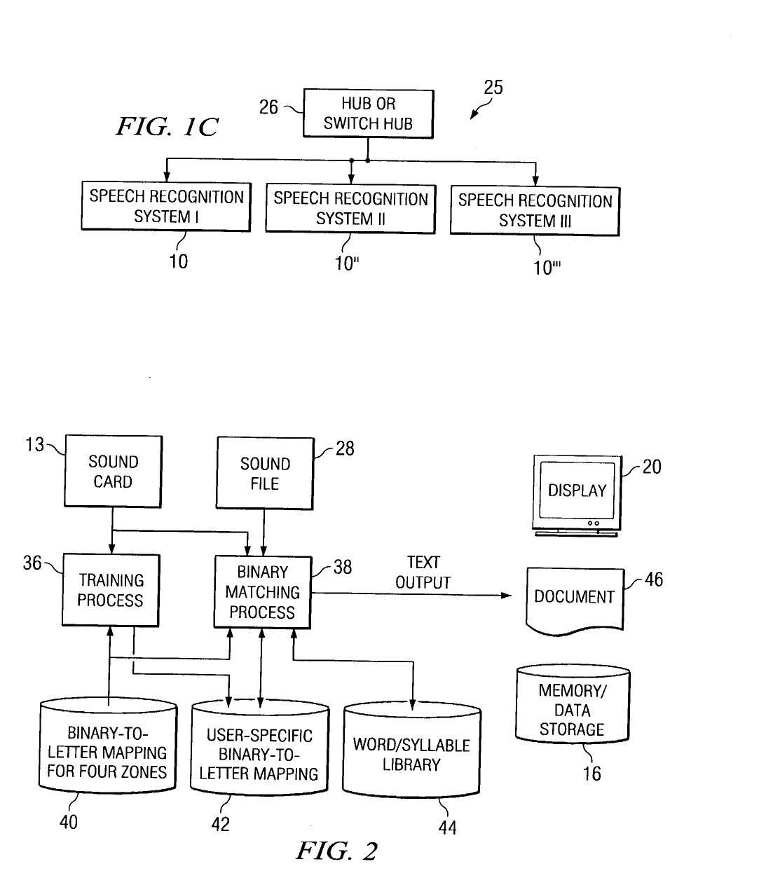

FIG. 2 is a functional block diagram of an embodiment of the speech recognition system according to the teachings of the present invention. The speech recognition system of the present invention is operable to convert continuous natural speech to text, where the speaker is not required to pause deliberately between words and does not need to adhere to a set of grammatical constraints. Digital binary data from sound card 13 is used as input to a training process 36 and a binary matching process 38 of speech recognition system 10.

During the training or speaker enrollment process 36, a binary-to-character mapping database 40 is consulted to determine a speech zone for the speaker. During the training process, a user-specific binary-to-character mapping database 42 is built by storing the binary-to-character mapping associated with the speaker. User-specific binary-to-character mapping database 42 is consulted during speech recognition binary matching process 38. During the speech recognition binary matching process, the binary bit stream received from sound card 13 or obtained from sound file 28 is parsed and converted to a character representation of the letters in each word by consulting user-specific binary-to-character mapping database 42 and word/syllable database 44. In word/syllable database 44, the words are arranged alphabetically and further according to the number of syllables in each word. The number of syllables in each word is used as another match criterion in database 44. Finally, the matched or nearest matched word is provided as text output on a display screen 20, written to a document 46, or stored in memory or data storage 16. Document 46 may then be transmitted and distributed electronically to other computers via facsimile, electronic mail, file transfer, and other means. The matched word may also be used as a command, such as spell, new line, new paragraph, capital, etc. Although databases 40, 42, and 44 are shown in FIG. 2 as separate blocks, they may be implemented together logically or on the same device for efficiency, speed, space and other considerations if so desired.

Databases 40-44 preferably contain corresponding binary codes and associated words that are commonly used by the particular user for a specific industry or field of use. For example, if the user is a radiologist and speech recognition system 10 is used to dictate and transcribe radiology or other medical reports, library 44 preferably contains a vocabulary anticipatory of such use. On the other hand, if speech recognition system 10 will be used by attorneys in their legal practice, for example, library 44 would contain legal terminology that will be encountered in its use.

FIG. 3 is a simplified flowchart of a training process 50 according to an embodiment of the invention. First, training process 50 prompts for, receives and stores the current speaker's name or identity, as shown in block 52. Training process 50 then display on the computer screen a training script and prompts the user to read it out loud into the microphone, as shown in block 54. The training script is preferably a set of known text that may be 4 to 5 paragraphs long. As the user reads the training script, output from sound card 13 is received, as shown in block 56. The sound card output is a binary bit stream. In block 58, the binary bits in the binary stream are parsed and grouped into N-bit groups, such as 8-bit groups, for example. The speaker's speech characteristics, as exemplified in the received binary bit stream, are analyzed, as shown in block 60. For example, the general or average frequency of the speaker's speech is analyzed and categorized into one of four zones, as shown in block 70.

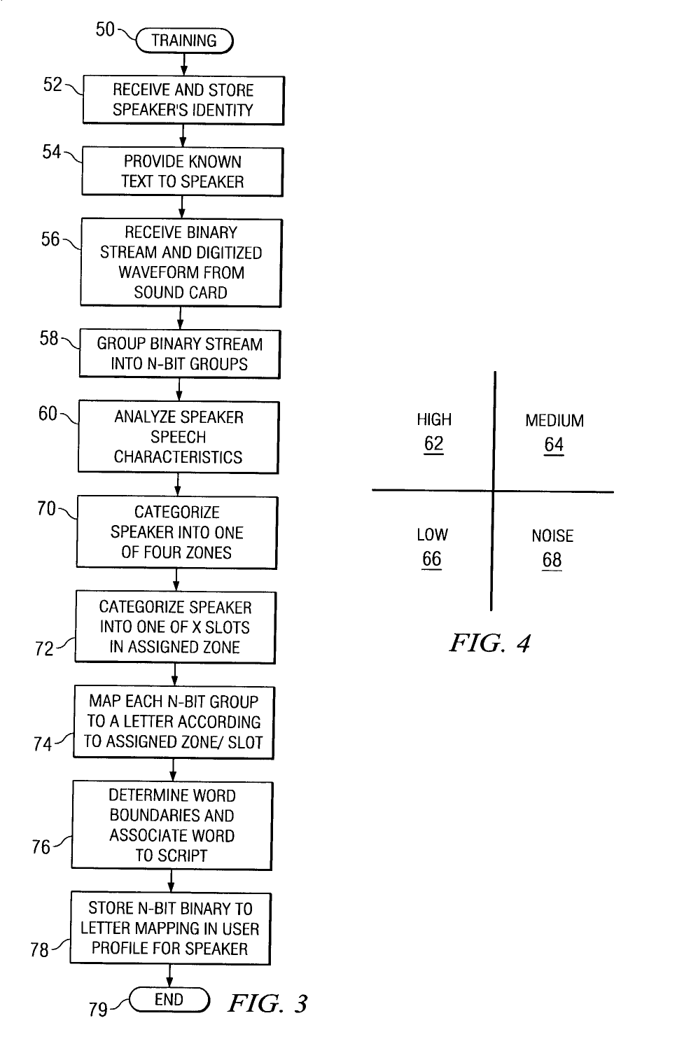

FIG. 4 is an exemplary plot of the four zones into which a speaker may be categorized. Zone 62 is characterized by a high frequency speech pattern. Most female speakers may be categorized into zone 62. Zone 64 is characterized by a medium frequency speech pattern, and zone 66 is characterized by a low frequency speech pattern. Zone 66 may include primarily male speakers. The last zone, zone 68, includes non-speech noise or sounds that cannot be discerned by system 10 as human speech. Music, machinery or equipment noise, animal sounds, etc. may be categorized as zone 68 sounds. In a preferred embodiment of the invention, the N-bit binary codes for each letter is compared with a plurality of thresholds. For example, if the binary codes generally fall between a particular set of upper and lower range values, then the speaker is categorized as a zone 62 speaker. Each zone is characterized by a respective upper threshold and a lower threshold, and they define the speech categorization of the speaker. In a preferred embodiment of the invention, As seen in block 72 of FIG. 3, the speaker is further identified as a speaker that falls into one of twenty-five “slots” within the zone. These slots represent further refinement of the frequency or other speech characteristics of the speaker's speech. These slots may also be defined by respective upper and lower thresholds. This analysis of the speaker's speech enhances the accuracy of speech recognition and transcription system 10.

After the speaker's speech zone and slot have been determined, these speech characteristics are stored. The N-bit groups of binary code are mapped to letters of known word in the script, as shown in block 74. In a preferred embodiment of the invention, each group of eight binary bits in the binary stream input is mapped to a character representation of a letter. For example, for a 16-bit sound card, each 16-bit grouping of binary bit stream is mapped to a letter. However, in the present embodiment, only the meaningful least significant 8 bits, for example, out of 16 bits are used to convert to the corresponding letter. As an example, the user speaks the words “Hello Joshua.” When speech recognition system 10 receives the binary bit stream from the sound card, only a subset of bits, may be needed from each 16-bit group in the binary bit stream for speech recognition. Therefore, the received binary bit stream may be:

01001110|01110101|01111100|01111100|101110111|00000000|01011010|10110111|01110111|01101110|101110110|01101101

where “|” is used to clearly demarcate the boundaries between the binary bit groups for the letters for increased clarity but does not represent a data output from the sound card. The binary-to-character mapping for the above example is shown below:

| | Encoded | | |
|---|---|---|---|
| Binary Bits | Character | ASCII | Unicode |
| 01001110 | H | 72 | u72 |
| 01110101 | e | 101 | u101 |
| 01111100 | l | 108 | u108 |
| 01111100 | l | 108 | u108 |
| 10110111 | o | 111 | u111 |
| 00000000 | space | 32 | u32 |
| 01011010 | J | 74 | u74 |
| 10110111 | o | 111 | u111 |
| 01110111 | s | 115 | u115 |
| 01101110 | h | 104 | u104 |
| 10110110 | u | 117 | u117 |
| 01101101 | a | 97 | u97 |

The binary bit stream is thus transformed into a serial sequence of letters. It should be noted that the binary bit-to-character is not a one-to-one mapping and that a plurality of different binary bit patterns may map into the same character due to the peculiarity or characteristics of the speaker's speech pattern. The binary-to-character mapping is determined on a speaker-by-speaker basis with data gathered during the speaker enrollment process. Therefore, each speaker in general has unique binary-to-character mapping that more accurately decode the speaker's speech.

The sequence of decoded letters is then parsed according to the detected boundaries between words. The word boundaries are characterized by binary bits that represent a space or pause between words. The words are thus derived from the sequence of letters and are associated with the known text in the script, as shown in block 76.

The binary-to-character mapping is then associated with the particular speaker and stored in memory, as shown in block 78. The binary code to letter mapping are then stored in user-specific database 42. The training process ends in block 79. It should be understood that the example above uses ASCII or Unicode as a character encoding format due to its universal application, but the present invention is not so limited.

Training process 50 may iteratively issue additional scripts of known text to the user and process the associated binary-to-character mapping as necessary. For users of a particular industry, system 10 may be tailored to provide training scripts containing specialized or technical terms and words associated with the industry so that a speaker's speech characteristics of these specialized words can be analyzed and stored to further enhance the accuracy of the system.

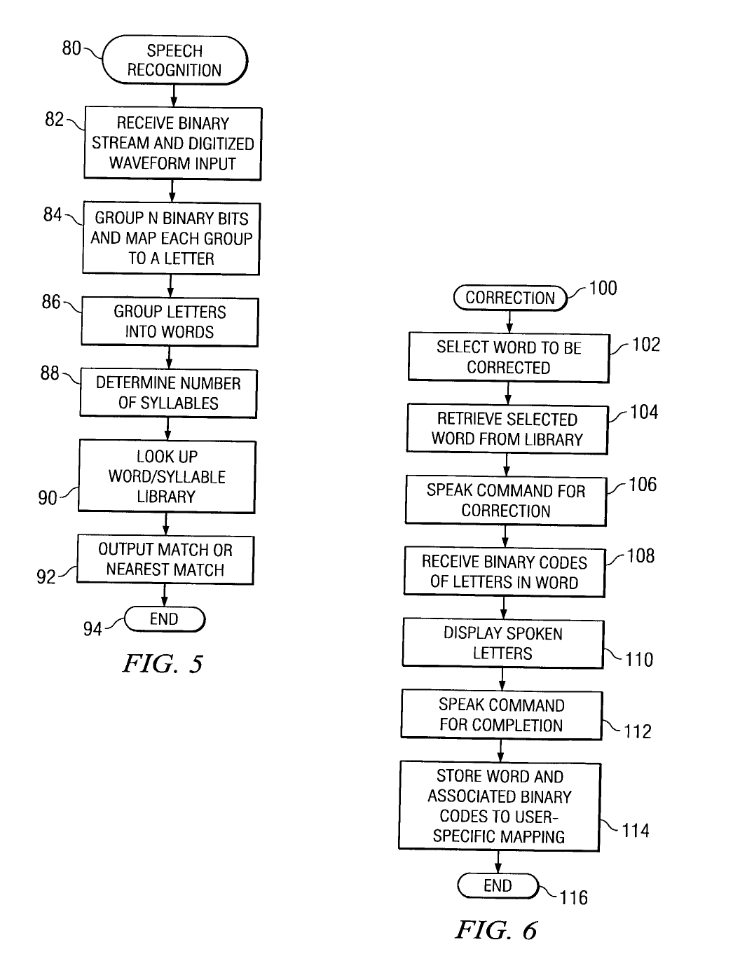

FIG. 5 is a simplified flowchart of an embodiment of the speech recognition process 80 according to the teachings of the present invention. Speech input is received from sound card 13 or obtained from sound file 28 in the form of a digitized waveform or binary bit stream, as shown in block 82. The binary bits in the bit stream are grouped into N-bit groups. As describe above, a preferred embodiment of the invention groups the binary bits into 8-bit groups and maps each group into a letter according to binary-to-character mapping for four speech zones database 40 and/or user-specific binary-to-character mapping database 42. Due to peculiarities of the English language and/or each speaker's speech characteristics, more than one different binary bit patterns may map into a single character. The binary-to-character mapping is determined on a speaker-by-speaker basis with data gathered during the speaker enrollment process. Therefore, each speaker in general has unique binary-to-character mapping that more accurately decode the speaker's speech. The digital binary stream is thus mapped to a sequence of letters, as shown in block 84. The binary bit stream is thus transformed into a letter stream. The letter stream is then parsed according to boundaries between words, as shown in block 86. The word boundaries are characterized by binary bits that represent a pause or silence between words. The resultant word may contain one or more letters that were not decodable to a recognizable letter. For example, in the “Hello Joshua” example above, the resultant binary-to-character mapping and word parsing steps may yield “H*llo Joshua,” with * denoting an undecipherable letter, for example. Speech recognition process 80 of the present invention uses further techniques to transcribe the uttered speech.

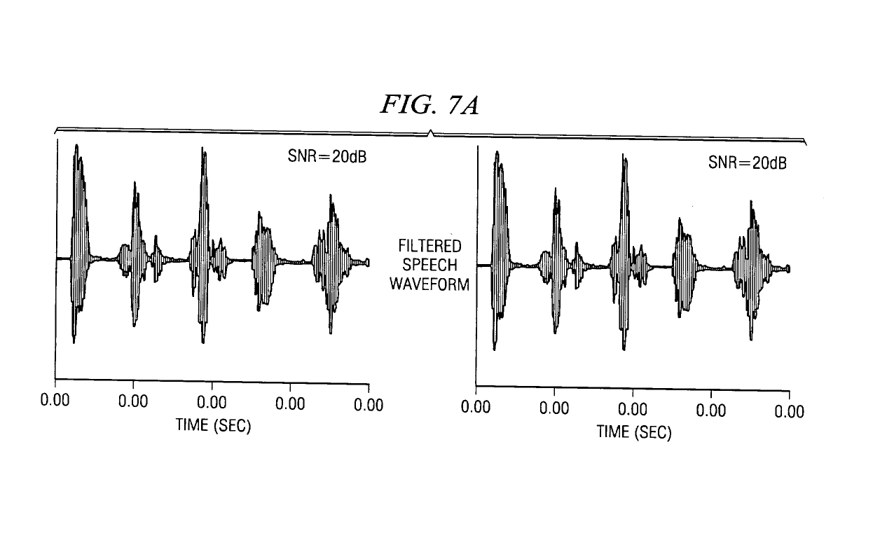

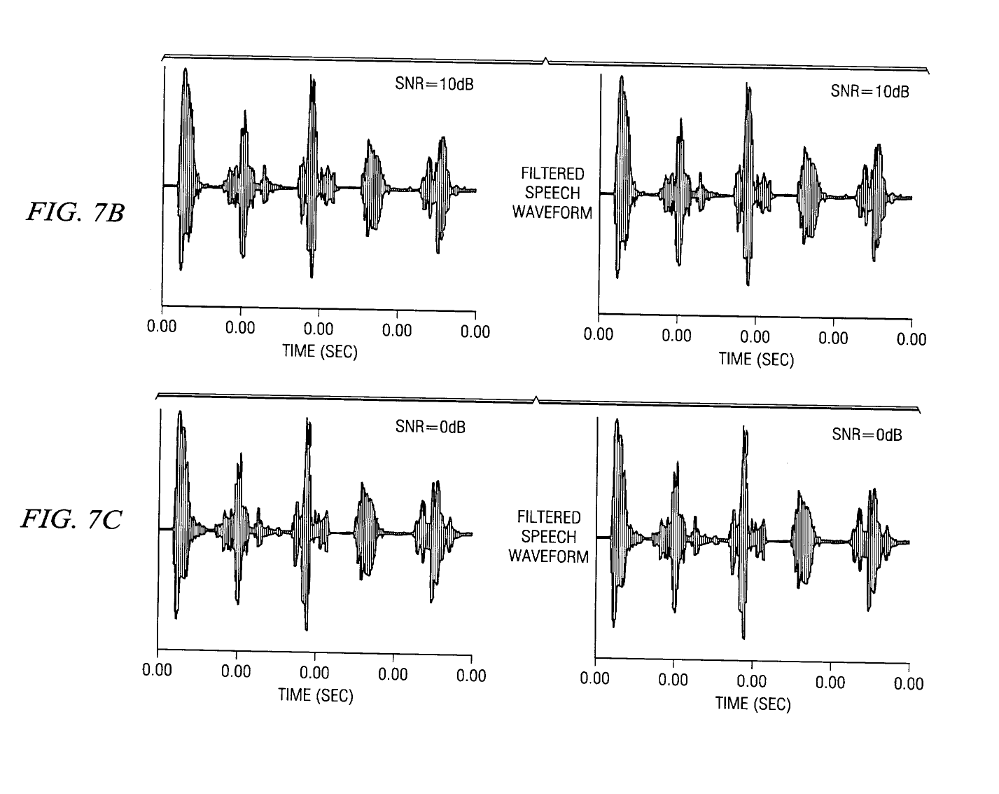

The received speech waveform from the sound card is further analyzed to determine how many syllables are in each uttered word, as shown in block 88. It may be seen in the time varying waveforms of three different individuals uttering the words “Hello Joshua” in FIGS. 7A-7C that the presence of each syllable can be easily identified and counted. A syllable is characterized by a tight grouping of peaks exceeding a predetermined amplitude and separated from other syllables by waveforms having zero or very small amplitudes. Thus, the presence of each syllable can be easily identified and the syllables counted. The number of syllables along with the binary-to-character representation for the word are used as match characteristics or search indices when a word/syllable library 44 is searched, as shown in block 90. Accordingly, words in library 44 are preferably arranged alphabetically and also according to the number of syllables in each word. An example of selected entries of the library is shown below:

| | | | Library | | Main | Key | |
|---|---|---|---|---|---|---|---|
| Words | Syllable | Abbr. | Train | User | entry | Tag | Command |
| All-Caps-Off | | | | | | *** | Lcase |
| All-Caps-On | | | | | | *** | Ucase |
| axial | 3 | * | * | | ax·i·al | * | |
| | (′ak-sE-&l) | | | | | | |
| centimeter | 4 | cm | * | | cen·ti·me·ter | * | |
| | (′sen-t&-″mE-t&r | | | | | | |
| hello | 2 | * | * | | hel·lo | * | |
| | (h&-′lO, he-) | | | | | | |
| millimeter | 4 | mm | Millimeter | B | mil·li·me·ter | */** | |
| | (′mi-l&-″mE-t&r) | | (B) | | | | |
| New | | | | | | *** | New |
| Paragraph | | | | | | | Section |
| pancreas | 3 | | Pancreas | A | pan·cre·as | */** | |
| | ′pa[ng]-krE-&s | | (A) | | | | |
| reach | 1 (rEch) | * | Reach | A, B | reach | */** | |
| | | | (A) | | | | |
| visceral | 3 | | Visceral | C | vis·cer·al | */** | |
| | (′vi-s&-r&l) | | (C) | | | | |
| what | 1 (′hwät) | * | | | what | * | |

The notations are defined as: “*” meaning the particular word is in the library; “**” meaning the particular word already exists in the library but has been specifically trained by a particular user because of trouble with the recognition of that word in the existing library; “***” meaning the particular word is in the library but is designated as commands to be executed, not provided as output text. If more than one user has trained on a particular word, the corresponding user column entry would identify all the users. It may be seen that the library entries for words commonly used in their abbreviated versions, such as centimeter/cm, millimeter/mm, include the respective abbreviations. The user may optionally select to output the abbreviations in the settings of the system whenever a word has an abbreviation in the library. Upper case letters may be determined by grammar or syntax, such as names, place names, or at the beginning of a sentence, for example. Symbols such as “ , ; : ! ? and # require the user to use a command, such as “open quotation” for inserting a “ symbol.

If a match is found in block 90, then the matched word is provided as text output. If there is no identical match, a short list of words that are the closest match may be displayed on the screen to allow the user to select a word. The selection of a word would create an association of that word in library 44 or user-specific library 42. Alternatively, speech recognition process 80 may automatically select the nearest word match according to some rating or analytical method. The matched word is then provided as an output, as shown in block 92. The speech recognition process of continues until the dictation session is terminated by the user, as shown in block 94.

Currently known and future techniques to relate stored data elements may be used to correlate the speech waveform and the word in the library, such as using a relational database. If a sufficiently close or identical match cannot be found, then the user is prompted to train the system to recognize that word. The user is prompted to spell out the word so that it may be stored in library 44 along with the digitized waveform and binary data stream of the word.

FIG. 4 is a flowchart of an embodiment of a correction process 100 of the speech recognition system according to the teachings of the present invention. The correction process may be entered into automatically and/or at the request of the user. For example, the user may issue a keyboard or verbal command to spell out a word, which directs speech recognition system 10 to enter into the training mode. The user first selects the word to be corrected, as shown in block 102. The user may use the pointing device to click on the word displayed on the computer screen to perform the selection, or utter commands to move the cursor to the word to be corrected. The selected word is retrieved from library 44, as shown in block 104. The user then speaks the command for correcting the selected word, a shown in block 106. For example, the user may say, “Spell” to correct the selected word. Process 100 then receives the binary stream for the spelling of the selected word, as shown in block 108. The spoken letters are decoded and displayed on the computer screen to give immediate feedback to the user, as shown in block 110. During this time, the user may issue further commands to reposition the cursor or to delete certain letters, such as “Go back,” “Select A,” etc. When the word is correctly received by process 100, the user may speak another command to indicate the completion of the correction process, as shown in block 112. The received word input, digitized waveform and the number of syllables for the word are associated with one another and stored in library 44 (or in the appropriate database or tables), as shown in block 114. An appropriate notation is further associated with the word to indicate that a particular user has provided user-specific waveform for the particular word. The correction process ends in block 116.

Speech recognition system 10 can be easily adapted to languages other than English. A binary conversion table for the target language is needed to adapt system 10 to another language. Languages not based on an alphabet system can be adapted because the tone of the spoken word is used in the binary code mapping. For example, for a character-based language such as Chinese, the binary code can be directly mapped to Chinese characters.

While the invention has been particularly shown and described by the foregoing detailed description, it will be understood by those skilled in the art that mutations, alterations, modifications, and various other changes in form and detail may be made without departing from the spirit and scope of the invention.

What is claimed is:

1. A method for speech recognition, comprising:
receiving a digital representation of speech;
grouping the digital representation of speech into subsets;
mapping each subset of the digital representation of speech into a character representation of speech;
grouping the character representations of speech into words;
determining the number of syllables in the digital representation of each word; and
searching a library containing words arranged according to the number of syllables and finding at least one closest match to each word.

2. The method, as set forth in claim 1, wherein receiving digital representation of speech comprises receiving a binary bit stream.

3. The method, as set forth in claim 2, wherein grouping the digital representation of speech into subsets comprises grouping N-bits of the binary bit stream.

4. The method, as set forth in claim 3, wherein mapping each subset of the digital representation of speech comprises mapping each N-bit binary group into a letter.

5. The method, as set forth in claim 4, wherein grouping the character representations of speech comprises grouping letters into one or more words.

6. The method, as set forth in claim 1, further comprising displaying the at least one closest match on a computer screen.

7. The method, as set forth in claim 6, further comprising receiving a user input selecting one of the at least one closest match displayed on the computer screen.

8. The method, as set forth in claim 1, further comprising inputting the at least one closest match into a document in a word processing application.

9. The method, as set forth in claim 8, further comprising storing the document.

10. The method, as set forth in claim 1, wherein receiving digital representation of speech comprises receiving a digital waveform representation of the speech.

11. The method, as set forth in claim 1, further comprising:
receiving a user identity;
providing a script of known text to a user;
receiving a digital representation of speech of the script read by the user;
grouping the digital representation of speech into subsets;
comparing the subsets to predetermined thresholds and assigning the user to a speech zone in response to the comparisons; and
storing the user identity and the speech zone assignment associated therewith.

12. The method, as set forth in claim 11, wherein receiving a digital representation of speech comprises receiving a binary bit stream.

13. The method, as set forth in claim 12, wherein grouping the digital representation of speech comprises grouping N-bits of binary bits.

14. The method, as set forth in claim 13, wherein comparing the subsets to predetermined thresholds comprises comparing N-bit binary bits to at least one of upper and lower thresholds of a plurality of speech zones.

15. The method, as set forth in claim 13, wherein comparing the subsets to predetermined thresholds comprises comparing N-bit binary bits to at least one of upper and lower thresholds of a plurality of speech zones and a plurality of slots within each speech zone.

16. The method, as set forth in claim 13, wherein storing the user identity and the speech zone assignment comprises storing the user identity and speech zone assignment in a user-specific database.

17. The method, as set forth in claim 13, further comprising mapping each subset of the digital representation of speech into a character representation of speech according to the speech zone assignment of the user;
grouping the character representations of speech into words;
determining the number of syllables in the digital representation of each word; and
searching a library containing words arranged according to the number of syllables and finding at least one closest match to each word.

18. The method, as set forth in claim 13, wherein comparing the subsets to predetermined thresholds and assigning the user to a speech zone comprises comparing the subsets to values representing frequency thresholds.

19. The method, as set forth in claim 13, wherein comparing the subsets to predetermined thresholds and assigning the user to a speech zone comprises comparing the subsets to values representing tone thresholds.

20. A speech recognition and transcription method, comprising:
receiving a user identity;
providing a script of known text to a user;
receiving a digital representation of speech of the script spoken by the user;
grouping the digital representation of speech into subsets;
comparing the subsets to predetermined thresholds and assigning the user to a speech zone in response to the comparisons; and
storing the user identity and the speech zone assignment associated therewith.

21. The method, as set forth in claim 20, wherein receiving a digital representation of speech comprises receiving a binary bit stream.

22. The method, as set forth in claim 21, wherein grouping the digital representation of speech comprises grouping N-bits of binary bits.

23. The method, as set forth in claim 22, wherein comparing the subsets to predetermined thresholds comprises comparing N-bit binary bits to at least one of upper and lower thresholds of a plurality of speech zones.

24. The method, as set forth in claim 23, wherein comparing the subsets to predetermined thresholds comprises comparing N-bit binary bits to at least one of upper and lower thresholds of a plurality of speech zones and a plurality of slots within each speech zone.

25. The method, as set forth in claim 20, wherein storing the user identity and the speech zone assignment comprises storing the user identity and speech zone assignment in a user-specific database.

26. The method, as set forth in claim 20, further comprising mapping each subset of the digital representation of speech into a character representation of speech according to the speech zone assignment of the user;
grouping the character representations of speech into words;
determining the number of syllables in the digital representation of each word; and
searching a library containing words arranged according to the number of syllables and finding at least one closest match to each word.

27. The method, as set forth in claim 20, wherein comparing the subsets to predetermined thresholds and assigning the user to a speech zone comprises comparing the subsets to values representing frequency thresholds.

28. The method, as set forth in claim 20, wherein comparing the subsets to predetermined thresholds and assigning the user to a speech zone comprises comparing the subsets to values representing tone thresholds.

29. The method, as set forth in claim 20, further comprising:
receiving a digital representation of speech dictated by the user;
grouping the digital representation of speech into subsets;
mapping each subset of the digital representation of speech into a character representation of speech according to the assigned speech zone of the user;
grouping the character representations of speech into words;
determining the number of syllables in the digital representation of each word; and
searching a library containing words arranged according to the number of syllables and finding at least one closest match to each word.

30. The method, as set forth in claim 29, wherein receiving digital representation of speech comprises receiving a binary bit stream.

31. The method, as set forth in claim 30, wherein grouping the digital representation of speech into subsets comprises grouping N-bits of the binary bit stream.

32. The method, as set forth in claim 31, wherein mapping each subset of the digital representation of speech comprises mapping each N-bit binary group into a letter.

33. The method, as set forth in claim 32, wherein grouping the character representations of speech comprises grouping letters into one or more words.

34. The method, as set forth in claim 29, further comprising displaying the at least one closest match on a computer screen.

35. The method, as set forth in claim 34, further comprising receiving a user input selecting one of the at least one closest match displayed on the computer screen.

36. The method, as set forth in claim 29, further comprising inputting the at least one closest match into a document in a word processing application.

37. The method, as set forth in claim 36, further comprising storing the document.

38. The method, as set forth in claim 29, wherein receiving digital representation of speech comprises receiving a digital waveform representation of the speech.

39. A speech recognition and transcription method, comprising:
receiving and storing a user identity from a user;
displaying a script of known text;
receiving a binary bit stream representation of the script spoken by the user;
grouping the binary bit stream into N binary bit groups;
comparing the N binary bit groups to predetermined thresholds and assigning the user to one of a plurality of speech zones in response to the comparisons; and
storing the speech zone assignment associated with the stored user identity.

40. The method, as set forth in claim 39, wherein comparing the N-bit groups to predetermined thresholds comprises comparing N bit binary bit groups to at least one of upper and lower thresholds of the plurality of speech zones and a plurality of slots within each speech zone.

41. The method, as set forth in claim 39, further comprising mapping each N binary bit group into a character representation of speech according to the speech zone assignment of the user;
grouping the character representations of speech into words;
determining the number of syllables in each word; and
searching a library containing words arranged according to the number of syllables and finding at least one closest match to each word.

42. The method, as set forth in claim 39, wherein comparing the N binary bit groups to predetermined thresholds and assigning the user to a speech zone comprises comparing the N binary bit groups to values representing frequency thresholds.

43. The method, as set forth in claim 39, wherein comparing the N binary bit groups to predetermined thresholds and assigning the user to a speech zone comprises comparing the N binary bit groups to values representing tone thresholds.

44. A method for speech recognition, comprising:
receiving a binary bit stream representative of speech;
grouping the binary bit stream into N-bit groups;
mapping each N-bit group into a character and generating a stream of characters from the binary bit stream; and
parsing the stream of characters into groups of characters representative of words.

45. The method, as set forth in claim 44, further comprising:
determining the number of syllables in each group of characters; and
searching a library containing words arranged according to the number of syllables and finding at least one closest match to each group of characters.

46. The method, as set forth in claim 44, further comprising receiving a user input selecting one of the at least one closest match displayed on the computer screen.

47. The method, as set forth in claim 45, further comprising inputting the at least one closest match into a document in a word processing application.

48. The method, as set forth in claim 44, further comprising:
receiving a user identity;
providing a script of known text to a user;
receiving a binary bit stream representative of the script read by the user;
grouping the binary bit stream into N-bit groups;
comparing the N-bit groups to predetermined thresholds and assigning the user to a speech zone in response to the comparisons; and
storing the user identity and the speech zone assignment associated therewith.

49. The method, as set forth in claim 48, wherein comparing the N-bit groups to predetermined thresholds comprises comparing N-bit binary bits to at least one of upper and lower thresholds of a plurality of speech zones.

50. The method, as set forth in claim 48, wherein comparing the N-bit groups to predetermined thresholds comprises comparing N-bit binary bits to at least one of upper and lower thresholds of a plurality of speech zones and a plurality of slots within each speech zone.

51. The method, as set forth in claim 49, further comprising:
mapping each N-bit group into a character representation of speech according to the speech zone assignment of the user;
grouping the character representations of speech into words.

52. The method, as set forth in claim 51, further comprising:
determining the number of syllables in each word; and
searching a library containing words arranged according to the number of syllables and finding at least one closest match to each word.

53. The method, as set forth in claim 48, wherein comparing the N-bit groups to predetermined thresholds and assigning the user to a speech zone comprises comparing the subsets to values representing frequency thresholds.

54. The method, as set forth in claim 48, wherein comparing the N-bit groups to predetermined thresholds and assigning the user to a speech zone comprises comparing the subsets to values representing tone thresholds.
